(19) United States
(12) Patent Application Publication
(10) Pub. No.: US 2019/0156284 A1
(43) Pub. Date: May 23, 2019

(54) LOGISTICS DATA MANAGEMENT METHOD AND SYSTEM THEREOF

(71) Applicant: Goldtek Technology Co., Ltd., New Taipei City (TW)

(72) Inventors: YEN-CHING LEE, New Taipei (TW); PO-SHENG WANG, New Taipei (TW); YU-CHANG SONG, New Taipei (TW)

(21) Appl. No.: 15/913,858

(22) Filed: Mar. 6, 2018

(30) Foreign Application Priority Data
Nov. 23, 2017 (TW) 106140785

(51) Int. Cl. G06Q 10/08; H04W 4/029

(52) U.S. Cl. CPC G06Q 10/08355; H04W 4/029; G06Q 10/08345

(57) ABSTRACT

The present disclosure provides a logistics data management performed by an electronic device. The electronic device comprises a processor. The logistics data management method comprises below steps. The electronic device receives a consignment note. The consignment note comprises a sending location and a receiving location corresponding to the sending location. The processor determines whether to initiate a direct delivery service by at least one parameter of the sending location and the receiving location. When the processor determines to initiate a direct delivery service, the electronic device provides a command of direct delivery service. The parameter of the sending location and the receiving location is a district, a distance, a transportation cost or a transportation time.

### CROSS-REFERENCE TO RELATED APPLICATIONS

This application claims priority to Taiwanese Invention Patent Application No. 106140785 filed on Nov. 23, 2017, the contents of which are incorporated by reference herein.

### FIELD

The present disclosure generally relates to a logistics data management method and system thereof. More particularly, the present disclosure relates to a logistics data management method capable of coordinating and providing direct delivery services.

### BACKGROUND

Currently, a delivery service is divided into several transportation steps in a conventional logistics process. Referring to FIG. 1, a conventional logistics process is illustrated. A1 to A6 are sending locations, each having corresponding receiving locations D1 to D6. Items, such as goods, from sending locations A1 to A6 are transported to goods collecting locations by a logistics service provider, such as stores B1 to B4 and transfer stations C1 to C2. Using sending location A6 and its corresponding receiving location D6 as an example, a small logistics truck T1 picks up an item at the sending location A6. The small logistics truck T1 transports the item to the store B2 for collecting and sorting. Then, a medium logistics truck T2 transports the item from the store B2 to the transfer station C1. Then, a large logistics truck T3 transport the item from the transfer station C1 to the transfer station C2. From the transfer station C2 to the store B4, the item is transported by a medium logistics truck T4. At last, the item is delivered from the store B4 to its receiving location D6 by a small logistics truck T5. Such multiple-steps delivery service is suitable for a long-range delivery, allowing items can be efficiently sorted and collected according to their sending locations and receiving locations. However, the multiple-steps delivery service is not efficient for a short-range delivery. In the short-range delivery, the multiple-steps delivery service causes a longer delivery time, and a higher delivery cost.

Therefore, there is a need to provide a more efficient logistics method to reduce delivery cost and provide a better delivery service; especially for short-range deliveries.

### SUMMARY

In view of above, the object is to provide a logistics data management method and system thereof. The logistics data management method analyzes the sending location and the receiving location of a consignment note. When the sending location and the receiving location are calculated to meet the requirement of a direct delivery service, the logistics data management method adds the receiving location to the route of the logistics truck that is responsible for picking up items. An item of the direct delivery service is directly delivered to its receiving location without transporting to a goods collecting location defined by a logistics service provider. Accordingly, the logistics data management method reduces delivery cost and delivery time of a conventional method. Meanwhile, recipients can receive their items more quickly.

### BRIEF DESCRIPTION OF THE DRAWINGS

Implementations of the present technology will now be described, by way of example only, with reference to the attached figures.

FIG. 1 a schematic view of a conventional logistics process.

FIG. 2A is a hardware block diagram of an electronic device that performs a logistics data management method; FIG. 2B is a function block diagram of the electronic device of FIG. 2A.

FIG. 3 is a flowchart of the logistics data management method according to a first exemplary embodiment.

FIG. 4 is a flowchart of the logistics data management method according to a second exemplary embodiment.

FIG. 5 is a schematic view of the logistics data management method according to a preferred exemplary embodiment.

FIG. 6 is a flowchart of the logistics data management method according to a third exemplary embodiment.

FIG. 7A is a route of a logistics truck of picking-up services according to a plurality of sending locations; FIG. 7B is a renewed route of the logistics truck after adding receiving locations of direct delivery services.

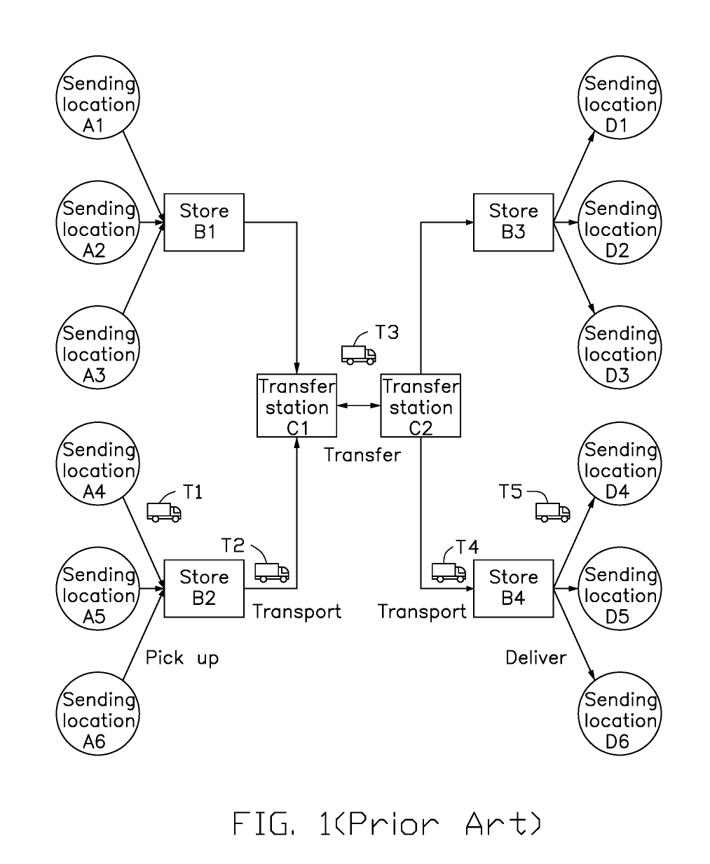

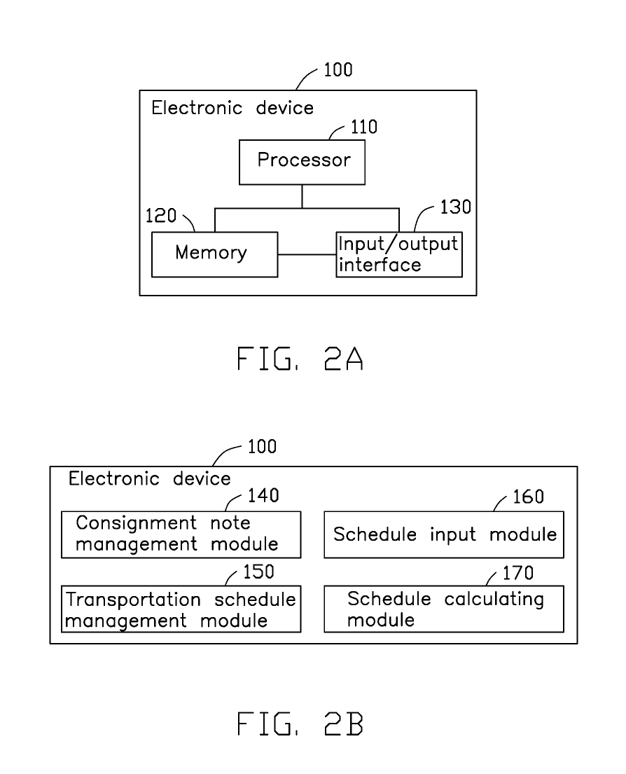

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these exemplary embodiments are provided so that this disclosure will be thorough and complete, and will fully convey the scope of the disclosure to those skilled in the art. Like reference numerals refer to like elements throughout.

The terminology used herein is for the purpose of describing particular exemplary embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The description will be made as to the exemplary embodiments in conjunction with the accompanying drawings in FIG. 2A to 7B. Reference will be made to the drawing figures to describe the present disclosure in detail, wherein depicted elements are not necessarily shown to scale and wherein like or similar elements are designated by same or similar reference numeral through the several views and same or similar terminology.

The present disclosure will be further described hereafter in combination with figures.

Referring to FIGS. 2A and 2B, an electronic device of performing a logistics data management method is illustrated. FIG. 2A is a hardware block diagram of the electronic device. FIG. 2B is a function block diagram of the electronic device of FIG. 2A. As shown in FIG. 2A, the electronic device 100 for performing the logistics data management method comprises: a processor 110, a memory 120 and an input/output interface 130. The processor 110 connects to the memory 120 and the input/output interface 130. The electronic device 100 can be a logistics server to receive, store and process various logistics data. The input/output interface 130 receives data or commands from users. The memory 120 stores the logistics data. The processor 110 processes the logistics data.

Referring to FIG. 2B, the electronic device 100 comprises various software function modules for logistics data management. For example, the electronic device 100 comprises a consignment note management module 140, a transportation schedule management module 150, a schedule input module 160, and a schedule calculating module 170. The consignment note management module 140 stores an information of the consignment note to be executed. The information of the consignment note comprises a serial number, a sender, a sending location, a recipient, a receiving location and a goods description. The transportation schedule management module 150 stores a schedule of transportation predefined by a logistics service provider. The transportation schedule management module 150 also produces a next step transportation according to the consignment note. The schedule of transportation comprises a plurality of goods collecting locations and logistics rules defined by the logistics service provider. The goods collecting location comprises stores and transfer stations. The schedule input module 160 produces or renews a logistics requesting location. The logistics requesting location comprises a location and a requesting type. The requesting type is picking-up, transferring or delivering. The schedule calculating module 170 calculates a route of a logistics vehicle (such as a logistics truck). The route is calculated based on a shortest-route-method, a shortest-time-method, a lowest-cost-method, or other methods defined by the logistics server provider.

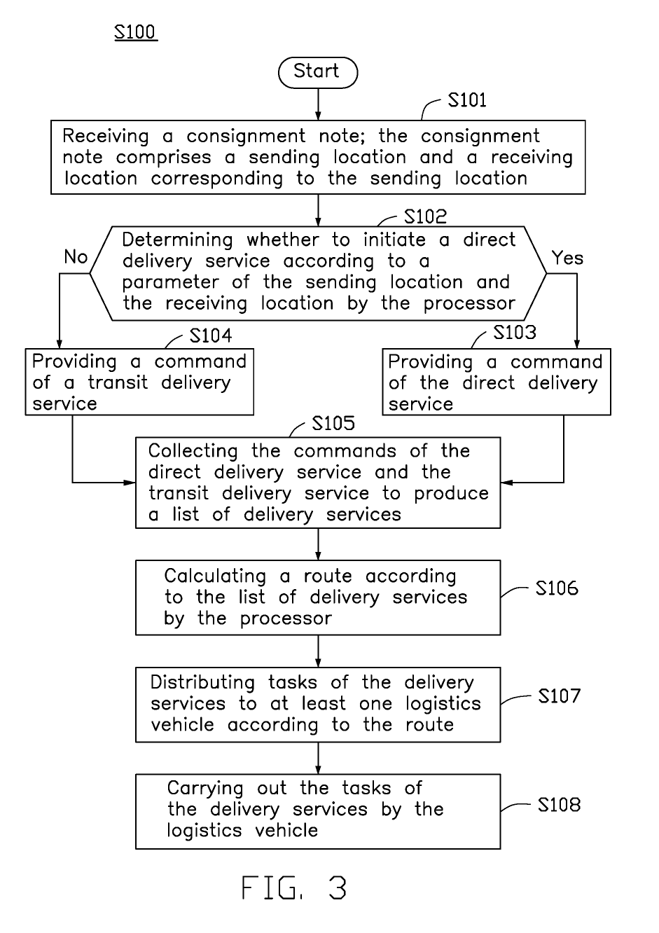

The logistics data management method is executed by an electronic device, such as the electronic device 100 shown in FIG. 2A. Referring to FIG. 3, a flowchart of the logistics data management method S100 according to a first exemplary embodiment is illustrated. The logistics data management method S100 comprises steps S101 to S108. In step S101, the electronic device 100 receives a consignment note. The consignment note comprises a sending location and a receiving location corresponding to the sending location. Besides the sending location and the receiving location, the consignment note further comprises a serial number, a sender, a recipient, and a goods description.

In step S102, the processor 110 determines whether to initiate a direct delivery service according to at least one parameter of the sending location and the receiving location. The parameter is a district, a distance, a transportation cost or a transportation time. The district comprises a postal code. The direct delivery service is to directly deliver an item from its sending location to its receiving location by the logistics truck that picks up the item, without transporting the item to any intermediate goods collecting location defined by the logistics service provider. Accordingly, the recipient can receive the item more quickly; and the delivery cost can be reduced.

In step S103, when the processor 110 determines to initiate the direct delivery service, the electronic device 100 provides a command of the direct delivery service. The command of the direct delivery service allows the item of direct delivery service to be directly delivered from its sending location to its receiving location by the logistics truck that picks up the item, without transporting the item to any intermediate goods collecting location defined by the logistics service provider (such as stores or transfer stations). For example, when the sending location and the receiving location are located in a same district (such as downtown Pittsburgh), the electronic device 100 provides the command of the direct delivery service. The logistics truck that picks up the item receives the command of the direct delivery service. Accordingly, the logistics truck that picks up the item directly delivers the item to the item's receiving location without transporting the item to any intermediate goods collecting location defined by the logistics service provider. Or, when the distance between the sending location and the receiving location is less than a predetermined value (such as less than 5 kilometers), the electronic device 100 provides the command of the direct delivery service. The logistics truck that picks up the item receives the command of the direct delivery service and directly delivers the item to its receiving location. Or, when the transportation cost from the sending location to the receiving location is less than a predetermined value (such as less than 1 dollar), the electronic device 100 provides the command of the direct delivery service. The logistics truck that picks up the item receives the command of the direct delivery service and directly delivers the item to its receiving location. Or, when the transportation time from the sending location to the receiving location is less than a predetermined value (such as less than 20 minutes), the electronic device 100 provides the command of the direct delivery service. The logistics truck that picks up the item receives the command of the direct delivery service and directly delivers the item to its receiving location.

In step S104, when the processor 110 determines not to initiate the direct delivery service, the electronic device 100 provides a command of a transit delivery service. The command of the transit delivery service allows the item of transit delivery to be transported to a goods collecting location defined by the logistics service provider (such as stores or transfer stations). The transit delivery service divides the delivery from the sending location to the receiving location into a multiple-steps delivery. For example, when the sending location and the receiving location are not located in the same district, the electronic device 100 provides the command of the transit delivery service. The logistics truck that picks up the item receives the command of the transit delivery service. Accordingly, the logistics truck that picks up the item transports the item to the intermediate goods collecting location defined by the logistics service provider, such as a store or a transfer station.

In step S105, the electronic device 100 collects the commands of the direct delivery service and the transit delivery service to product a list of delivery services. The list of delivery services comprises the item's next stop and next operation. If the item is an item of direct delivery service, the item's next stop is its corresponding receiving location; and the item's next operation is delivery. If the item is an item of transit delivery service, the item's next stop is a goods collecting location defined by the logistics service provider (such as a store or a transfer station); and the item's next operation is transferring.

In step S106, the processor 110 calculates a route according to the list of delivery services. The route is calculated based on a shortest-route-method, a shortest-time-method, a lowest-cost-method, or other methods defined by the logistics server provider.

In step S107, the electronic device 100 distribute tasks of the delivery services to at least on logistics vehicle (such as a logistics truck) according to the route. In step S108, the logistics vehicle carries out the task of the delivery services.

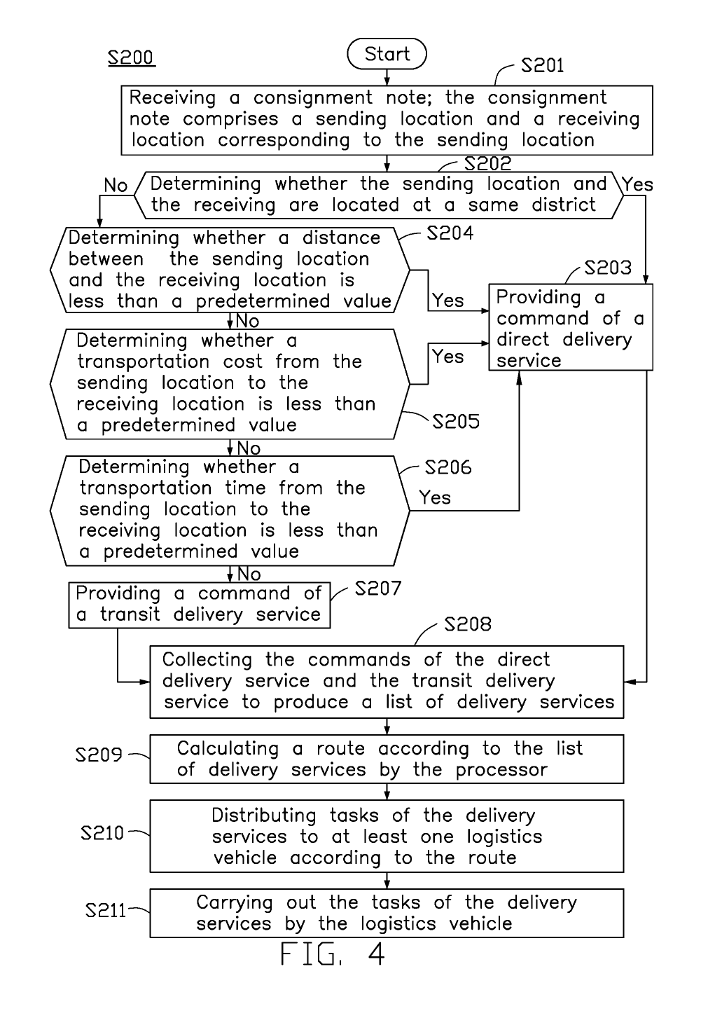

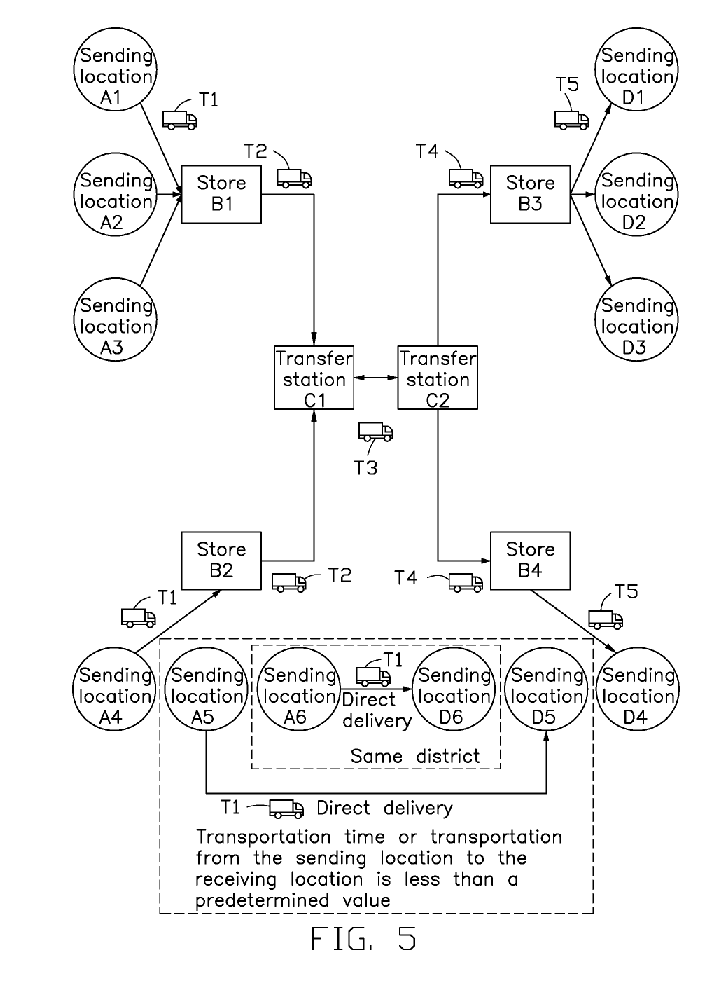

Referring to FIG. 4, a flowchart of the logistics data management method S200 according to a second exemplary embodiment. The logistics data management method S200 is performed by an electronic device. The electronic device can be referred to the electronic device 100 as shown in FIG. 2A. As shown in FIG. 4, the logistics data management method S200 comprises steps of S201 to S211. In step S201, the electronic device 100 receives a consignment note. The consignment note comprises a sending location and a receiving location corresponding to the sending location. In step S202, the processor 110 determines whether the sending location and the receiving location are located in a same district. In the processor 110 determines that the sending location and the receiving location are located at the same district, the electronic device provides a command of a direct delivery service. The command of the direct delivery service allows the item of direct delivery service to be directly delivered from its sending location to its receiving location by the logistics truck that picks up the item, without transporting the item to any intermediate goods collecting location defined by the logistics service provider (such as stores or transfer stations). In step S204, when the processor 110 determines that the sending location and the receiving location are not located at the same district, the processor 110 determines whether a distance between the sending location and the receiving location is less than a predetermined value (such as less than 5 kilometers). If the determination in step S204 is YES, the logistics data management method proceeds S200 step S203. If the determination in step S204 is NO, the logistics data management method S200 proceeds step S205. In step S205, the processor 110 determines whether a transportation cost from the sending location to the receiving location is less than a predetermined value (such as less than 1 dollar). If the determination in step S205 is YES, the logistics data management method S200 proceeds step S203. If the determination in step S205 is NO, the logistics data management method S200 proceeds step S206. In step S206, the processor 110 determines whether a transportation time from the sending location to the receiving location is less than a predetermined value (such as less than 20 minutes). If the determination in step S206 is YES, the logistics data management method S200 proceeds step S203. If the determination in step S206 is NO, the logistics data management method S200 proceeds step S207.

In step S207, the electronic device 100 provides a command of a transit delivery service. The command of the transit delivery service allows the item of transit delivery to be transported to a goods collecting location defined by the logistics service provider (such as stores or transfer stations). The transit delivery service divides the delivery from the sending location to the receiving location into a multiple-step delivery. In step S208, the electronic device 100 collects the commands of the direct delivery service and the transit delivery service to product a list of delivery services. The list of delivery services comprises the item's next stop and next operation. If the item is an item of direct delivery service, the item's next stop is its corresponding receiving location; and the item's next operation is delivery. If the item is an item of transit delivery service, the item's next stop is a goods collecting location defined by the logistics service provider (such as a store or a transfer station); and the items' next operation is transferring. In step S209, the processor 110 calculates a route according to the list of delivery services. The route is calculated based on a shortest-route-method, a shortest-time-method, a lowest-cost-method, or other methods defined by the logistics server provider. In step S210, the electronic device 100 distribute tasks of the delivery services to at least on logistics vehicle (such as a logistics truck) according to the route. In step S211, the logistics vehicle carries out the task of the delivery services.

Referring to FIG. 5, a schematic view of the logistics data management method according to a preferred exemplary embodiment is illustrated. As shown in FIG. 5, sending locations A1 to A6 are respectively corresponding to receiving locations D1 to D6. Goods collecting locations, defined by the logistics service provider, may be stores B1 to B4 and transfer stations C1 and C2. Items sent from sending locations A1 to A3 are picked up and transported to the store B1 by a small logistics truck T1, transported from the store B1 to the transfer station C1 by a medium logistics truck T2, and transported from the transfer station C1 to the transfer station C2 by a large logistics truck T3. The items are sorted at the transfer station C2, and then transported from the transfer station C2 to the store B3 by a medium logistics truck T4. At last, the items are delivered from the store B3 to their corresponding receiving location D1 to D3. Similarly, the item sent from the sending location A4 is sequentially transported to the store B2 by the logistics truck T1, to the transfer station C1 by the logistics truck T2, to the transfer station C2 by the logistics truck T3, to the store B4 by the logistics truck T4, and finally delivered to the corresponding receiving location D4 by the logistics truck T5.

Since the distance or the transportation time between the sending location A5 and its corresponding receiving location is less than a predetermined value (for example the distance is less than 5 kilometers or the transportation time is less than 20 minutes), the item sent from sending location A5 is delivered by the direct delivery service. The item sent from the sending location A5 is directly delivered to its corresponding receiving location D5 by the logistics truck T1, without transporting to any store or transfer station. Similarly, the sending location A6 and its corresponding receiving location D6 are located at the same district. The item sent from the sending location A6 is delivered by the direct delivery service. The item sent from the sending location A6 is directly delivered to its corresponding receiving location D6 by the logistics truck T1, without transporting to any store or transfer station. Therefore, the logistics data management method analyzes the sending location and the receiving location of a consignment note. When the sending location and the receiving location are calculated to meet the requirement of a direct delivery service, the logistics data management method provides a command of the direct delivery service. The logistics data management method collects the commands of the direct delivery service and the transit delivery service to produce a list of delivery services. Also, a route is calculated based on the list of delivery services. Logistics trucks carry out picking-up services and delivery services based on the route. Accordingly, the logistics data management method reduces delivery cost and delivery time of a conventional method. Meanwhile, recipients can receive their items more quickly.

The present disclosure also disclose a logistics data management system. The logistics management system comprises an electronic device 100 as shown in FIG. 2A. Also, the logistics data management system performs the logistics data management method S100 as shown in FIG. 3. The electronic device 100 and the logistics data management method S100 can be referred to above exemplary embodiments without further description.

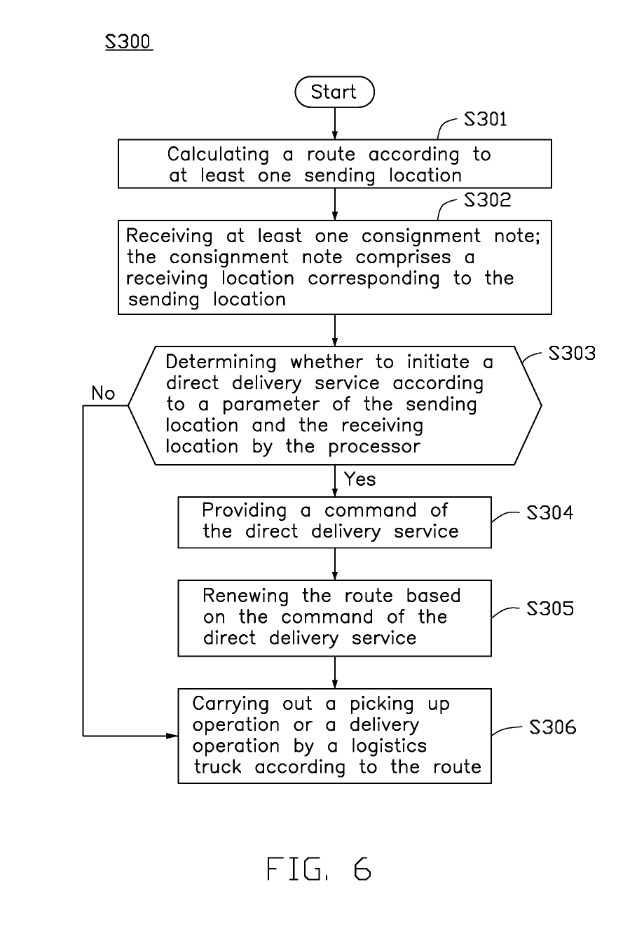

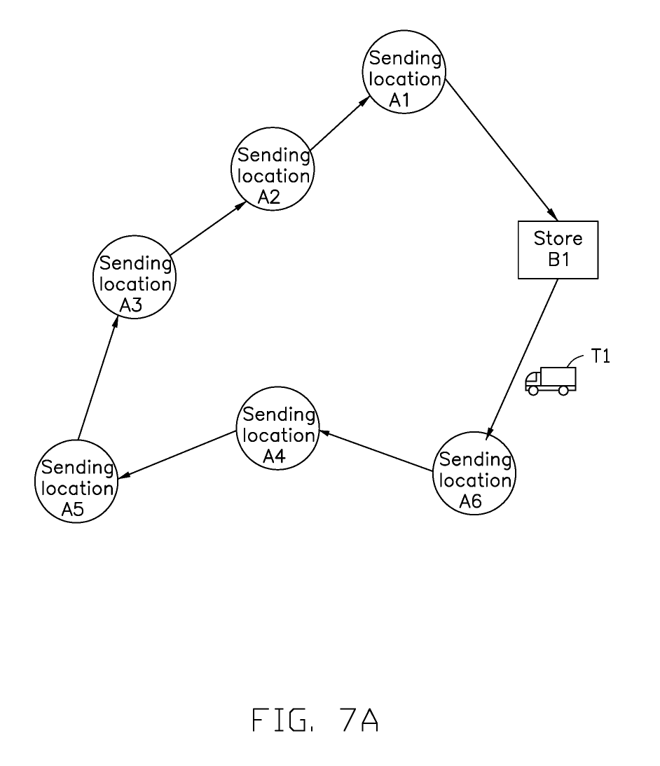

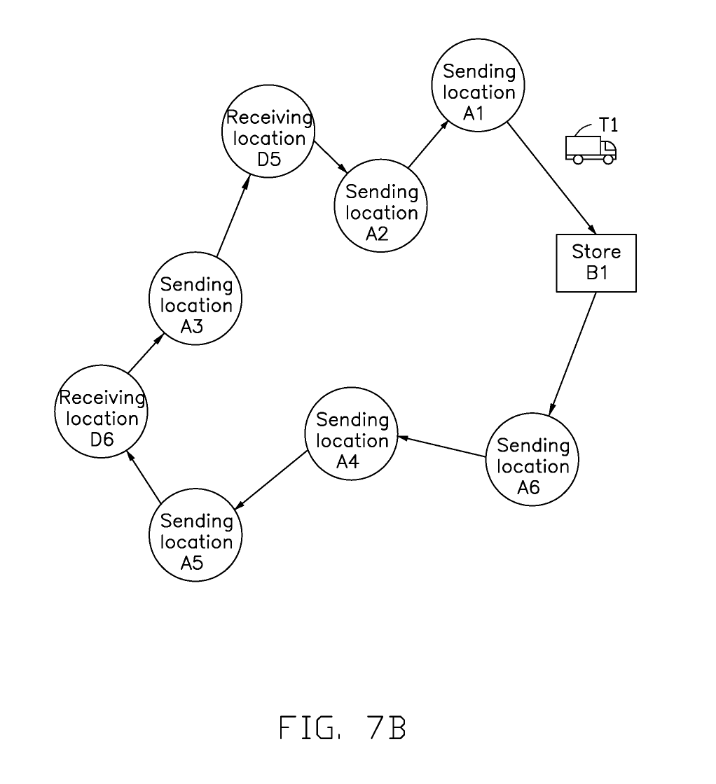

Referring to FIGS. 6, 7A and 7B, FIG. 6 is a flowchart of the logistics data management method according to a third exemplary embodiment. FIG. 7A is a route of a logistics truck of picking-up services according to a plurality of sending locations. FIG. 7B is a renewed route of the logistics truck after adding receiving locations of direct delivery services. As shown in FIG. 6, the logistics data management method S300 comprises steps S301 to S306. The logistics data management method S300 is performed by the electronic device 100 as shown in FIG. 2A. In step S301, the electronic device 100 calculates a route according to at least one sending location. Usually, before a logistics truck picking up items, the pick-up route of the logistics truck is calculated based on a plurality of predetermined sending locations. The sending location can be appointed by a sender or predefined by the logistics service provider. For example, as shown in FIG. 7A, a logistics truck T1 that departs from a store B1 should go to sending locations A1 to A6 to pick up items. The pick-up route for the logistics truck T1 is calculated by a shortest-route-method. Accordingly, the logistics truck T1 sequentially stops at the sending location A6, the sending location A4, the sending location A5, the sending location A3, the sending location A2 and the sending location A1 to pick up items. After picking up items from each sending location, the logistics truck T1 will return to the store B1. In step S301, the electronic device 100 further provides a command of picking up at the sending location.

In step S302, the electronic device 100 receives at least one consignment note. The consignment note comprises a receiving location corresponding to the sending location. Specifically, when a logistics personnel gets the consignment note, the information of the consignment note can be input to a handhold device by scanning or typing-in manually. The information of the consignment note is transmitted from the handhold device to the electronic device 100 wirelessly. Besides the receiving location, the consignment note further comprises a serial number, a sender, a recipient, and a goods description.

In step S303, the processor 110 of the electronic device 100 determines whether to initiate a direct delivery service according to at least one parameter of the sending location and the receiving location. The parameter of the sending location and the receiving location is a district, a distance, a transportation cost or a transportation time. The district comprises a postal code. The direct delivery service is to directly deliver an item from its sending location to its receiving location by the logistics truck that picks up the item, without transporting the item to any intermediate goods collecting location defined by the logistics service provider. Accordingly, the recipient can receive the item more quickly; and the delivery cost can be reduced.

In step S304, when the processor 110 determines to initiate the direct delivery service, the electronic device 100 provides a command of the direct delivery service. The command of the direct delivery service allows the item of direct delivery service to be directly delivered from its sending location to its receiving location by the logistics truck that picks up the item, without transporting the item to any intermediate goods collecting location defined by the logistics service provider (such as stores or transfer stations). For example, when the sending location and the receiving location are located in a same district (such as downtown Pittsburgh), the electronic device 100 provides the command of the direct delivery service. The logistics truck that picks up the item receives the command of the direct delivery service. Accordingly, the logistics truck that picks up the item directly delivers the item to the item's receiving location without transporting the item to any intermediate goods collecting location defined by the logistics service provider. Or, when the distance between the sending location and the receiving location is less than a predetermined value (such as less than 5 kilometers), the electronic device 100 provides the command of the direct delivery service. The logistics truck that picks up the item receives the command of the direct delivery service and directly delivers the item to its receiving location. Or, when the transportation cost from the sending location to the receiving location is less than a predetermined value (such as less than 1 dollar), the electronic device 100 provides the command of the direct delivery service. The logistics truck that picks up the item receives the command of the direct delivery service and directly delivers the item to its receiving location. Or, when the transportation time from the sending location to the receiving location is less than a predetermined value (such as less than 20 minutes), the electronic device 100 provides the command of the direct delivery service. The logistics truck that picks up the item receives the command of the direct delivery service and directly delivers the item to its receiving location.

In step S305, the processor 110 renews the route according to the command of the direct delivery service. In step S306, a logistics truck carries out a picking-up operation or a delivery operation according to the renewed route. If the determination in step S303 is NO, the logistics data management method S300 proceeds step S306, the processor 110 dose not renew the route; and the logistics truck goes to the next sending location to pick up items according to the original route.

As shown in FIG. 7B, when the logistics truck T1 is picking up items at the sending location A6, the electronic device 100 receives a consignment note of the sending location A6. The consignment note of the send location A6 shows that its sending location and receiving location are at the same district. Therefore, the processor 110 provides the command of the direct delivery service for the item that is picked up at the sending location A6. The corresponding receiving location D6 is added to the route of the logistics truck T1. The route of the logistics truck T1 is renewed by the shortest-route method or other methods. Similarly, when the logistics truck T1 is picking up items at the sending location A5, the electronic device 100 receives a consignment note of the sending location A5. The consignment note of the sending location A6 shows that the distance its sending location and receiving location are less than a predetermined value (such as less than 5 kilometers). Therefore, the processor 110 provides the command of the direct delivery service for the item that is picked up at the sending location A5. The corresponding receiving location D5 is added to the route of the logistics truck T1. The route of the logistics truck T1 is renewed by the shortest-route method or other methods. The consignment notes of sending locations A4, A3, A2 and A1 does not fulfill the criteria of the direct delivery service. The items picked up at the sending locations A4, A3, A2 and A1 are delivered by the original transmit delivery service. The items picked up at the sending locations A4, A3, A2 and A1 are transported to a goods collecting location defined by the logistics service provider (such as a store or a transfer station). Therefore, the final route of the logistics truck when it returns to the store B1 is shown as FIG. 7B. The logistics truck T1 goes to every sending location or every receiving location to carry out picking-up operation or delivery operation. Specifically, after departing from the store B1, the logistics truck T1 sequentially picks up items at the sending location A6, picks up items at the sending location A4, picks up items at the sending location A5, delivers items at receiving location D6, picks up items at sending location A3, delivers items at receiving location D5, picks up items at the sending location A2, picks up items at the sending location A1, and finally returns to the store B1. After the logistics truck T1 returns to the store B1, the items picked up from the sending locations A1, A2, A3 and A4 are sorted and transported to the next goods collecting location or their corresponding receiving locations by the conventional transit delivery service. The items picked up from the sending locations A6 and A5 are respectively delivered to their receiving locations D6 and D5 by the logistics truck T1 before the logistics truck T1 returns to the store B1. Accordingly, the logistics truck T1 can carry out delivery operations during pick-up operations. The recipients can receive their items more quickly. The delivery time and delivery cost of the conventional transit delivery service can be reduced. Therefore, the logistics data management method can effectively reduce the logistics cost.

As described above, the logistics data management method analyzes the sending location and the receiving location of a consignment note. When the sending location and the receiving location are calculated to meet the requirement of a direct delivery service, the logistics data management method adds the receiving location to the route of the logistics truck that is responsible for picking up items. An item of the direct delivery service is directly delivered to its receiving location without transporting to a goods collecting location defined by a logistics service provider. Accordingly, the logistics data management method reduces delivery cost and delivery time of a conventional method. Meanwhile, recipients can receive their items more quickly.

The embodiments shown and described above are only examples. Many details are often found in the art such as the other features of a logistics data management method. Therefore, many such details are neither shown nor described. Even though numerous characteristics and advantages of the present technology have been set forth in the foregoing description, together with details of the structure and function , the disclosure is illustrative only, and changes may be made in the detail, especially in matters of shape, size, and arrangement of the parts within the principles, up to and including the full extent established by the broad general meaning of the terms used in the claims. It will therefore be appreciated that the embodiments described above may be modified within the scope of the claims.

What is claimed is:

1. A logistics data management method performed by an electronic device; wherein the electronic device comprises a processor, the method comprising:
receiving a consignment note, the consignment note indicating, for an item to be transported, a sending location of the item and a receiving location for the item;
the processor determining whether to initiate a direct delivery service according to at least one parameter of the sending location and the receiving location; and
when the processor determines to initiate the direct delivery service, providing a command to initiate the direct delivery service.

2. The logistics data management method of claim 1, wherein the parameter of the sending location and the receiving location is a district, a distance, a transportation cost or a transportation time.

3. The logistics data management method of claim 2, wherein the district comprises a postal code.

4. The logistics data management method of claim 1, wherein the consignment note further comprises a serial number, a sender, a recipient, and a goods description.

5. The logistics data management method of claim 1, further comprising:
when the processor determines not to initiate the direct delivery service, providing a command of a transit delivery service.

6. The logistics data management method of claim 5, further comprising:
collecting the commands of the direct delivery service and the transit delivery service to produce a list of delivery services;
calculating a route according to the list of delivery services by the processor; and
distributing tasks of the delivery services to at least one logistics vehicle according to the route.

7. A logistics data management method performed by an electronic device; wherein the electronic device comprises a processor; the logistics data management method comprising:
calculating a route according to at least one sending location;
receiving at least one consignment note; wherein the consignment note comprises a receiving location corresponding to the sending location;
determining whether to initiate a direct delivery service according to at least one parameter of the sending location and the receiving location by the processor; and
when the processor determines to initiate the direct delivery service, renewing the route by the processor.

8. The logistics data management method of claim 7, wherein the parameter of the sending location and the receiving location is a district, a distance, a transportation cost or a transportation time.

9. A logistics data management system comprising an electronic device; wherein the electronic device comprises a processor, a memory and an input/output interface; the processor connects to the memory and the input/output interface; the processor performs below steps:
receiving a consignment note; wherein the consignment note comprises a sending location and a receiving location corresponding to the sending location;
determining whether to initiate a direct delivery service according to at least one parameter of the sending location and the receiving location; and
when determining to initiate the direct delivery service, providing a command of the direct delivery service.

10. The logistics data management system of claim 9, wherein the parameter of the sending location and the receiving location is a district, a distance, a transportation cost or a transportation time.
